(19) United States
(12) Patent Application Publication
(10) Pub. No.: US 2010/0061521 A1
(43) Pub. Date: Mar. 11, 2010

(54) TRANSPARENT FILM FOR ATTACHING MARKERS OR SYMBOLS TO MEDICAL DEVICES OR BODY SURFACE AREAS OF PATIENTS

(76) Inventor: Robert Standar, Pretzfeld (DE)

Correspondence Address: BRINKS HOFER GILSON & LIONE, P.O. BOX 10395, CHICAGO, IL, 60610, US

(21) Appl. No.: 12/549,144

(22) Filed: Aug. 27, 2009

(30) Foreign Application Priority Data
Sep. 2, 2008 (DE) 10 2008 045 405.2

(51) Int. Cl. H05G 1/28

(52) U.S. Cl. 378/162

(57) ABSTRACT

A transparent film for attaching markers or symbols to medical devices or body surface areas of patients is provided. A first surface of the film is prepared such that it is as smooth and resistant to cleaning agents as possible. The second surface facing the first surface is imprinted with markers or with symbols and is provided with an adhesive layer after the imprinting process.

The present patent document claims the benefit of the filing date of DE 10 2008 045 405.2, filed Sep. 2, 2008, which is hereby incorporated by reference.

### BACKGROUND

It is necessary within different fields of technology or everyday applications to attach markers or symbols to the surfaces of devices. For examination purposes, markers or symbols may be attached to body surface areas of patients. Within the field of mammography, compression plates may be used with a number of holes, through which a tissue sample can be taken from the examined breast (mamma) with the aid of a biopsy needle after being x-rayed. The biopsy needle is prodded through the holes in the compression plate into the tissue of the breast.

The position of the holes with respect to the tissue parts shown in a mammographic image recording can be assigned as accurately as possible during the examination and its evaluation. To clearly identify the 45 holes in a compression plate, for example, a coordinate system etched into a steel plate is usually used in the analogue mammography device. This is normally glued to the compression plate. It is difficult to clean the coordinate system and, even after cleaning, slight residues from a disinfectant used for cleaning purposes get caught in the etched symbols of the coordinate system.

Digital mammography prohibits the use of steel due to the special features which are present here and relate to image generation and image processing. Compression plates used in digital mammography do not have labels for the holes. The user has to determine the rows of holes in which he/she is to place the biopsy needle by counting, this nevertheless being laborious and associated with errors according to experience.

Similar problems exist in other fields of technology. The field of medicine also has the problem of attaching markers or symbols to body surface areas of patients.

### SUMMARY

The present embodiments may obviate one or more of the problems or drawbacks inherent in the related art.

In one embodiment, a transparent film for attaching markers (M) or symbols to medical devices or body surface areas of patients is provided. The transparent film includes a first surface that it is as flat and resistant to cleaning agents as possible; and a second surface facing the first surface, the second surface being imprinted with markers or with symbols and an adhesive layer. The markers or symbols may include particles made of phosphor. Markers may illustrate a coordinate system. The adhesive layer may be a biocompatible adhesive layer.

### BRIEF DESCRIPTION OF THE DRAWINGS

FIG. 1 shows a schematic representation of a cross-section through an advantageous embodiment of a film.

FIG. 2 shows a schematic representation of an example of use of a coordinate system for marking holes in a mammography compression plate.

FIG. 3 shows a schematic representation of an inventive film comprising an exemplary coordinate system according to FIG. 2, which is attached to a mammography compression plate.

FIG. 4 shows a schematic representation of an example of use of an inventive film, which was attached to the body surface area of a patient to be examined.

### DETAILED DESCRIPTION

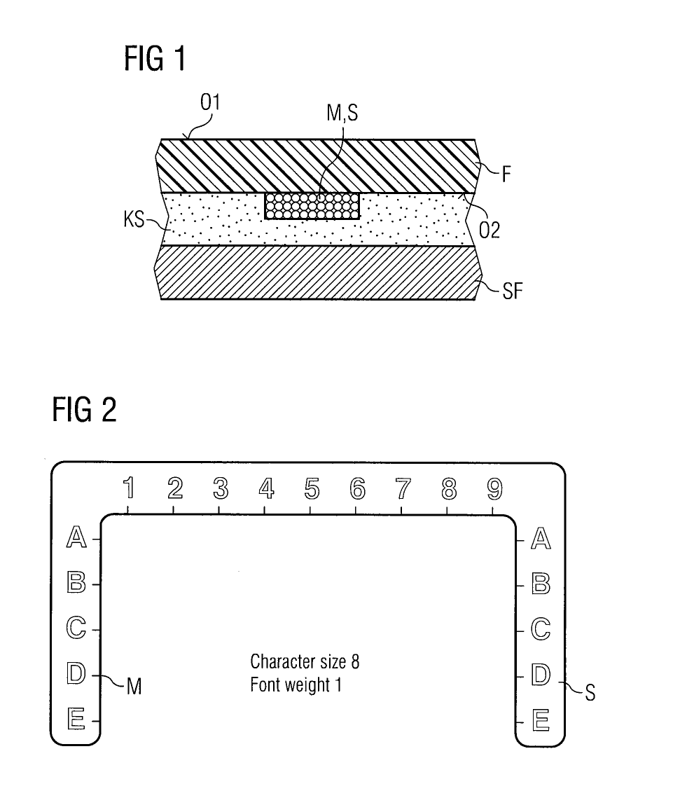

FIG. 1 illustrates one embodiment of a film (F). A first surface (O1) of the film (F) is prepared such that it is flat and resistant to cleaning agents. The second surface (O2), which faces the first surface (O1), is imprinted with markers (M) or with symbols (S) and is provided with an adhesive layer (KS) after the printing process.

FIG. 2 illustrates one embodiment of a coordinate system. The coordinate system or other markers or symbols may be negatively printed onto the rear of a preferably smudge-proof film. The printing ink may include phosphor particles. The layer thickness of the imprint may be 50μm or more. An adhesive layer is then attached, which attaches the film (F) to a compression plate, for example. The overall thickness of the film system may be less than O0.5 mm. The coordinate system may be used for marking holes in a mammography compression plate.

A conventional film made of polycarbonate may be used as the film material. The polycarbonate material may be a transparent (“crystal clear”) material. The markers (M) or symbols (S) are particularly easily visible in an x-ray image if they are printed from as thick a layer as possible of an as intensively absorbing material as possible, preferably in the screen printing method. Attempts have established an accentual color made of phosphor (green).

As shown in FIG. 1, the adhesive layer for mounting the film (F) may be covered with a protective film (SF), which can be easily removed prior to use.

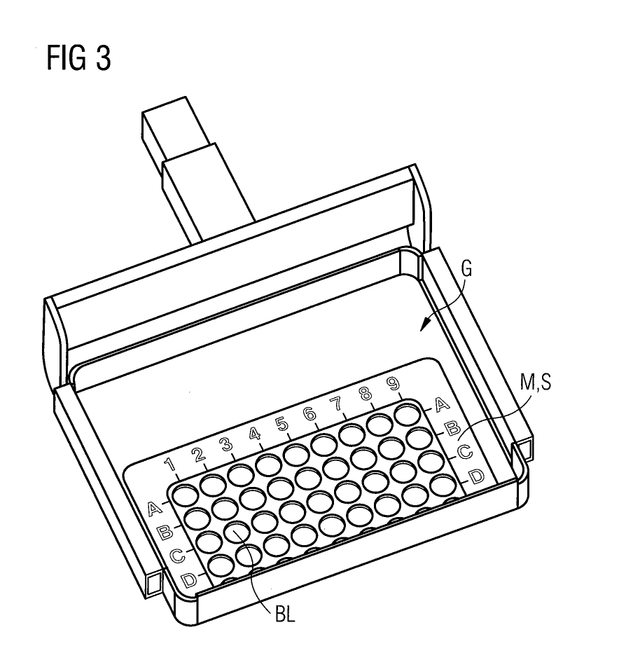

FIG. 3 shows a schematic representation of an inventive film comprising an exemplary coordinate system according to FIG. 2, which is attached to a mammography compression plate. Since the film surface remains outwardly flat, the imprinting process takes place as described above from the rear, cleaning of the film is possible without restrictions. The coordinate system, which is shown in the x-ray image, allows the user to easily and rapidly locate the rows of holes (BL) in order to perform the biopsy.

Accordingly, markers, rulers or symbols may be attached to fluoroscopy facilities or other device surfaces in order subsequently to render the markers, rulers, or symbols visible in the x-ray image.

Body markers and rulers can also be attached to a body part to be examined. These are provided with a preferably “biocompatible” adhesive (in other words an adhesive such as that used in band-aids). This “single ruler” can be easily cleaned up after the examination. The ruler is visible in the x-ray image and assists with localizing examination objects.

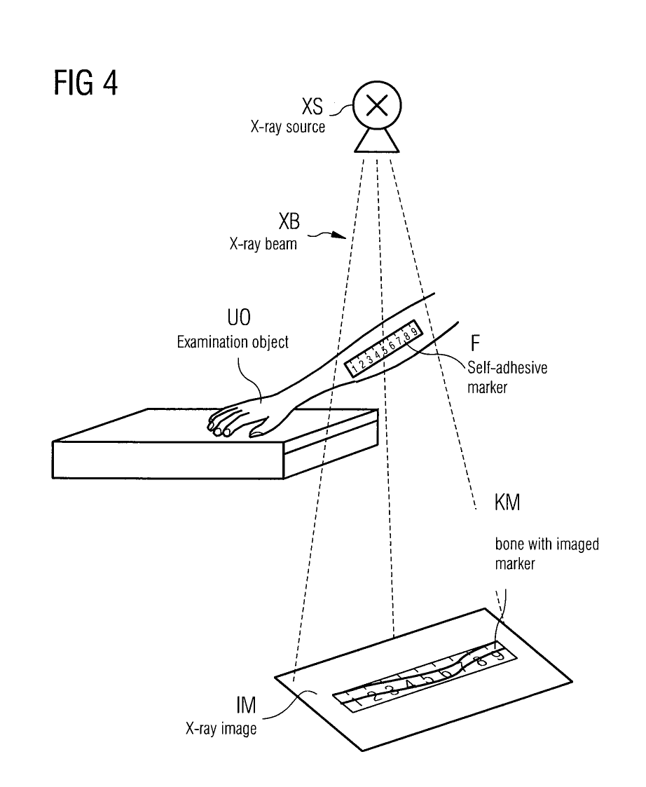

As shown in FIG. 4, the film (F) may be used to attach markers or symbols to the body surface areas of patients to be examined. If a coordinate system or a ruler is imprinted onto the film (F), for instance, and is the film is subsequently attached to a body surface area of a patient (UO) who is exposed to an x-ray (XB) from an x-ray source (XS), then the x-ray image (IM) obtains an image of the examination object (UO) together with the markers which are attached to the film.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A transparent film for attaching markers or symbols to medical devices or body surface areas of patients, the film comprising:
a first surface that is flat and resistant to cleaning agents;
a second surface facing the first surface, the second surface being imprinted with markers or with symbols and is provided with an adhesive layer.

2. The film as claimed in claim 1, wherein the markers or symbols include particles made of phosphor.

3. The film as claimed in claim 1, wherein the markers illustrate a coordinate system.

4. The film as claimed in claim 1, wherein the adhesive layer includes a biocompatible adhesive layer.

5. A method for producing a film, the method comprising:
a) imprinting a second surface of a transparent film, which faces a first surface that is as flat and resistant to cleaning agents as possible, with markers or with symbols;
b) subsequently, providing the second surface with an adhesive layer.

6. The method as claimed in claim 5, covering the adhesive layer with a protective film.

7. The method as claimed in claim 5, wherein the markers or symbols includes particles of phosphor.

8. The method as claimed in claim 5, further comprising arranging the markers or symbols as a coordinate system.

9. The method as claimed in claim 5, further comprising providing the second surface with a biocompatible adhesive layer.
